(19) United States
(12) Patent Application Publication
(10) Pub. No.: US 2007/0039501 A1
(43) Pub. Date: Feb. 22, 2007

(54) Plate making apparatus

(75) Inventor: Chikashi Ohishi, Shizuoka (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD

(21) Appl. No.: 11/505,901

(22) Filed: Aug. 18, 2006

(30) Foreign Application Priority Data
Aug. 19, 2005 (JP) 2005-238306

(51) Int. Cl. B41N 3/00

(52) U.S. Cl. 101/463.1

(57) ABSTRACT

A plate making apparatus makes a printing plate for lithographic printing. The apparatus includes a first inkjet head which ejects selectively a plate surface-protecting solution in response to a first ejection signal onto a printing base plate on which an image has been recorded. The plate making apparatus further includes a drying unit which dries the plate surface-protecting solution ejected selectively onto the printing base plate with the first inkjet head. The apparatus further includes a second inkjet head which ejects an image forming material onto the printing base plate in response to a second ejection signal, and a fixing unit which heats the image forming material ejected onto the printing base plate with the second inkjet head so that the image forming material is fixed as image areas.

The entire contents of documents cited in this specification are incorporated herein by reference.

### BACKGROUND OF THE INVENTION

The present invention belongs to a technical field of plate making apparatuses for producing lithographic printing plates. More specifically, the invention relates to a plate making apparatus in which a plate surface-protecting solution is selectively applied onto an image-forming surface of a printing plate on which an image has been recorded (image areas have been formed).

In conventional lithographic printing plates, an image has been recorded (image areas have been formed) on a presensitized plate (a printing base plate on which image areas are not formed) by outputting an original image to a silver halide photographic film in an analog or digital manner through an exposure process to form a film for plate making; exposing a diazo resin or a photopolymerizable photosensitive material (presensitized plate) to light bearing the original image using the plate making film; and removing non-image areas that are exposed or not exposed by dissolution mainly using an alkaline solution. Thus, a printing plate on which image areas are formed has been made through the plate making process described above, in other words, through photolithography.

JP 11-99759 A discloses a method of making a printing plate by forming an image (image areas) on a printing base plate (e.g. made of aluminum) on which image areas are not formed by an inkjet system using solid ink.

In such a plate making process, a plate surface-protecting solution, that is, a gum solution is applied onto the surface of a printing plate in its final step. Application of the gum solution onto the surface of the printing plate enables not only maintenance of the hydrophilicity in non-image areas but also protection of the plate against scratching and scumming that may be caused by fingerprints left on the plate, or fat, oil and dust adhered to the plate during the storage of the plate having been subjected to image corrections such as addition to or deletion from image areas until it is subjected to printing, during its storage until it is reused, during its mounting on a printing press, and during its handling. Scumming due to oxidization can also be suppressed.

Conventional apparatuses for applying a gum solution include roll coater type and spray type applicators. Such roll coater type and spray type applicators apply the gum solution onto the whole surface of the printing plate irrespective of whether it is applied to image areas or non-image areas.

An example of such apparatuses for applying a gum solution is found in JP 5-76768 U that discloses a gum solution applicator for printing plates using photosensitive lithographic printing base plates (presensitized plate) that includes a transport roller pair having an upper roller and a lower roller between which an inclined first contact surface is formed so as to feed a printing plate obliquely downward; an application roller pair having an upper roller and a lower roller between which a second contact surface substantially parallel to the first contact surface is formed in a higher position than the first contact surface so as to feed the printing plate transported through the transport roller pair obliquely downward; and a gum solution supplying means for supplying a gum solution to the printing plate which is passing through the application roller pair.

The gum solution applicator uniformly applies the gum solution over the whole upper surface of the printing plate that passes between the rollers of the application roller pair.

### SUMMARY OF THE INVENTION

However, in the conventional method in which a gum solution is applied onto the surface of a printing plate in which image areas are formed with an applicator of a roller coater type or spray type, or with the gum solution applicator disclosed in JP 5-76768 U, the gum solution is applied onto the whole surface of the printing plate including image areas and non-image areas, which results in the gum solution being used in a large amount, thus causing an increase in cost.

When the gum solution having been applied is to be dried, not only the applicator but also a dryer is necessary, which makes the apparatus upsized and also causes an increase in cost.

The present invention has been accomplished under these circumstances and an object thereof is to provide a small-sized plate making apparatus that is capable of applying a plate surface-protecting solution with a high degree of efficiency in a selective manner and preferably exclusively to non-image areas.

In order to attain the object described above, the present invention provides a plate making apparatus for making a lithographic printing plate, comprising: a first inkjet head which ejects selectively a plate surface-protecting solution in response to a first ejection signal onto said printing plate on which an image has been recorded.

It is preferable that the first inkjet head ejects selectively the plate surface-protecting solution on non-image areas of said printing plate.

It is preferable that the plate making apparatus further comprises a drying unit which dries said plate surface-protecting solution ejected selectively onto said printing plate with said first inkjet head.

It is preferable that the plate making apparatus further comprises a second inkjet head which ejects an image forming material onto a printing base plate on which image areas are not formed in response to a second ejection signal to form image areas on said printing base plate, thereby making said printing plate on which said image including said image areas and non-image areas has been recorded.

It is preferable that the plate making apparatus further comprises a fixing unit which heats said image forming material ejected onto said printing plate with said second inkjet head so that said image forming material is fixed as said image areas.

It is preferable that said fixing unit heats said image forming material ejected onto said printing plate to fix it as said image areas, and also dries said plate surface-protecting solution ejected selectively with said first inkjet head.

It is preferable that the fixing unit heats the image recording material ejected onto the printing plate to fix it as the image areas, while simultaneously drying the plate surface-protecting solution.

It is preferable that the image comprises ink receptive image areas and ink repellent non-image areas which have been formed on said printing plate, and said printing plate is ready to be used as a lithographic printing plate.

It is preferable that the first ejection signal is based on image data for recording said image.

It is preferable that the second ejection signal is based on image data for recording said image.

According to the present invention, the plate surface-protecting solution can be selectively ejected to necessary portions on the surface of a printing plate on which an image has been recorded by using the first inkjet head, which enables reduction of the amount of the plate surface-protecting solution used. The amount of the plate surface-protecting solution consumed can be thus reduced and the apparatus can be also downsized.

According to the present invention, in addition to the effect described above, ejecting the plate surface-protecting solution only to non-image areas can further reduce the amount of the solution used.

According to the present invention, in addition to the above effect, a printing plate for lithographic printing can be made without any development process by forming an image on a printing base plate with the second inkjet head, which enables further downsizing of the apparatus. The thus made printing plate can be used as a lithographic printing plate on which ink receptive image areas and ink repellent non-image areas are formed.

In addition to the above effect, the present invention is capable of drying the plate surface-protecting solution without the necessity of providing a new mechanism only by performing fixation of image areas and drying of the plate surface-protecting solution in one fixing unit. This enables a simpler configuration and downsizing of the apparatus.

### BRIEF DESCRIPTION OF THE DRAWINGS

FIG. 1 is a perspective view schematically showing the structure of a plate making apparatus according to an embodiment of the present invention;

FIG. 2 is a schematic cross-sectional view showing a part of the plate making apparatus shown in FIG. 1;

FIG. 3 is a schematic view showing how a head unit is moved;

FIG. 4 is a schematic structural view showing the appearance of an example of an inkjet head; and

FIG. 5 is a schematic structural view showing the periphery of a nozzle in the inkjet head shown in FIG. 4.

### DETAILED DESCRIPTION OF THE INVENTION

The plate making apparatus of the present invention is described below in detail with reference to preferred embodiment shown in the accompanying drawings.

In the present invention, a plate for use in printing is in general collectively referred to as a printing plate. Therefore, for example, one having an image recorded on part or the whole of its surface, in other words, one having image areas and non-image areas formed thereon, one that is ready for use in printing and one whose non-image areas are coated with a plate surface-protecting solution such as gum solution are all called the printing plate. However, when a support having no image formed on its surface, in other words, a support on which image areas and non-image areas are not formed at all, for example, a support such as a metal plate that was merely subjected to surface treatment for manufacturing a printing plate is only to be distinguished from the printing plate described above, this support is particularly referred to as a printing base plate.

A support that was subjected to surface treatment to impart ink repellency to its entire surface before ink receptive image areas and ink repellent non-image areas are formed therein is described below as a typical example of the printing base plate, and a plate that is ready for use as a lithographic printing plate, a plate on which ink receptive image areas and ink repellent non-image areas are formed, and a plate which is coated with a plate surface-protecting solution such as gum solution are described below as typical examples of the printing plate. However, as described above, these are not the sole cases of the present invention.

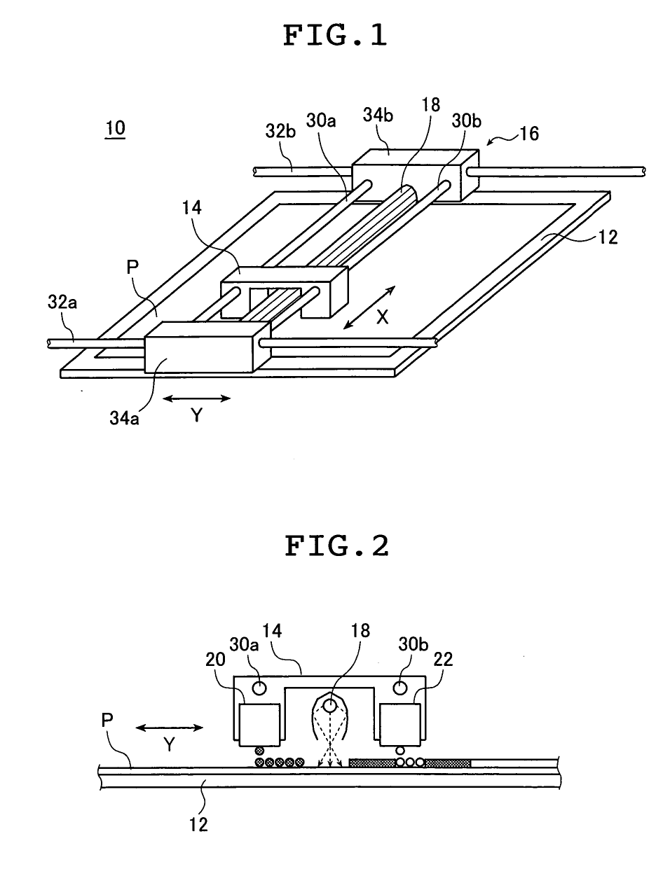

FIGS. 1 and 2 are schematic structural views showing a plate making apparatus according to an embodiment of the present invention.

A plate making apparatus 10 shown in FIG. 1 includes a support table 12 for a printing plate P, a head unit 14, head unit-scanning means 16, a heater 18, and a not-shown automatic plate feeder (plate feeding means) for feeding the printing plate to the support table 12. The automatic plate feeder (not shown) is a known apparatus for automatically feeding the printing plate P to the support table 12.

The support table 12 is flat and fixes the printing plate P fed from the automatic plate feeder at a predetermined position.

The head unit 14 includes an ink ejecting head 20 and a gum solution ejecting head 22, is disposed to face the support table 12 and is supported by the head unit scanning means 16 to be described later so as to be capable of moving parallel to the surface of the support table 12.

The ink ejecting head 20 ejects ink on the printing plate (printing base plate) P in response to a second ejection signal to record an image thereon to thereby form image areas thereon. The second ejection signal as used herein is an ejection signal which is derived from an image signal based on image data for recording the image and causes ink droplets to be ejected to selectively apply ink to portions corresponding to the image areas.

Various types of inkjet heads (ejection heads) including continuous types and drop-on-demand types (e.g., piezoelectric type, thermal type, solid type, electrostatic attraction type) can be used for the ink ejecting head. Various drop-on-demand types of inkjet heads can be more preferably used.

The gum solution ejecting head 22 ejects selectively the plate surface-protecting solution (hereinafter referred to simply as the gum solution) on non-image areas of the printing plate P in response to a first ejection signal onto the printing plate having an image formed with the ink ejecting head 20 to thereby form a gum solution coating in the non-image areas of the printing plate P. The head 22 is disposed in close proximity to the ink ejecting head 20. The first ejection signal as used herein is an ejection signal which is derived from an image signal and causes the gum solution to be ejected to selectively apply the gum solution to portions corresponding to the non-image areas. When the gum solution is applied to the non-image areas as in the embodiment under consideration, the inversion signal of the second ejection signal may be used as the first ejection signal.

As in the ink ejecting head 20, various types of inkjet heads can be used for the gum solution ejecting head 22. It is particularly preferable to use a piezoelectric or thermal drop-on-demand inkjet head for the gum solution ejecting head 22.

Washing water, a rinsing solution containing a surfactant and other ingredients, and a desensitizer containing gum arabic, a starch derivative and other ingredients as described in JP 59-58431 A, JP 55-115045 A and JP 54-8002 A, respectively, can be used for the gum solution.

The head unit scanning means 16 transports the head unit 14 in a main scanning direction (indicated by a double-headed arrow X in FIG. 1) and a sub scanning direction (indicated by a double-headed arrow Y in FIG. 1) and includes main scanning guide bars 30a and 30b, sub scanning guide bars 32a and 32b, and support members 34a and 34b.

The main scanning guide bars 30a and 30b are disposed at a predetermined distance from each other so as to be parallel to the main scanning direction in which the head unit 14 is transported.

One end of each of the main scanning guide bars 30a and 30b is supported by the support member 34a, whereas the other end thereof is supported by the support member 34b.

The head unit 14 described above is supported by the main scanning guide bars 30a, 30b and the support members 34a, 34b, and is moved in the main scanning direction along the main scanning guide bars 30a, 30b by drive units (not shown) provided in the support members 34a, 34b.

Such movement of the head unit 14 along the main scanning guide bars 30a, 30b enables its movement in the main scanning direction.

The sub scanning guide bars 32a, 32b are disposed at a predetermined distance from each other so as to be parallel to a direction orthogonally intersecting the main scanning guide bars 30a, 30b, that is, the sub scanning direction in which the head unit 14 is transported. The sub scanning guide bars 32a and 32b support the support members 34a and 34b, respectively.

Drive units (not shown) causes the sub scanning guide bars 32a, 32b to move the support members 34a, 34b in the sub scanning direction. The support members 34a, 34b are moved in synchronism so that they take the same positions in the sub scanning direction.

The movement of the support members 34a, 34b in the sub scanning direction enables the head unit 14 supported by the support members 34a, 34b and the main scanning guide bars 30a, 30b to be moved in the sub scanning direction.

The head unit scanning means 16 moves the head unit 14 in the main scanning direction and the sub scanning direction in the manner described above. The scanning operation with the head unit 14 as well as the method of making a printing plate will be described later in further detail.

The heater 18 is a rod-shaped heating device and is disposed between the main scanning guide bars 30a, 30b so as to be parallel thereto. The heater 18 is supported by the support members 34a, 34b. Various radiant heating sources such as a halogen heater lamp and an infrared heater can be used for the heater 18.

The heater 18 is moved in the sub scanning direction in synchronism with the movement of the support members 34a, 34b to heat the printing plate P to thereby fix the image areas formed with ink onto the printing plate P. Further, the heater 18 dries the gum solution coating formed from the gum solution in the non-image areas.

In the embodiment under consideration, the heater is used as a means for heating the printing plate P. However, the above-mentioned heating method is not the sole method to be applied and, for example, the heater may be brought into direct contact with the surface opposite to the surface of the printing plate P on which the image areas are formed, thereby heating the printing plate P through contact heating.

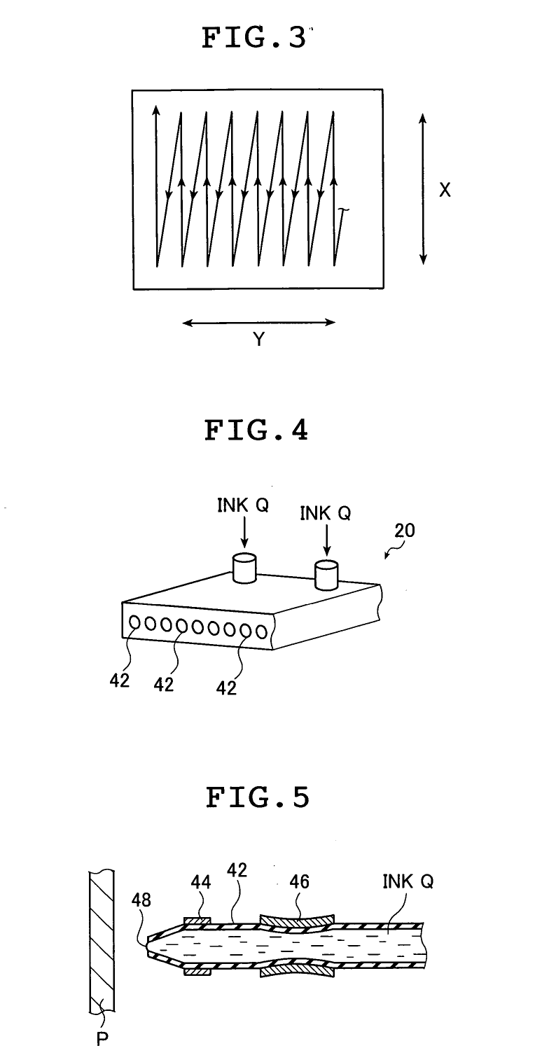

Next, the method of making a printing plate with the plate making apparatus 10 of the present invention is described. FIG. 3 is a schematic view showing an example of the moving path of the head unit 14.

First, a printing base plate P is mounted on the support table 12 by the automatic plate feeder (not shown).

Next, while the head unit 14 is moved, ink is ejected selectively onto the printing base plate P to form the image areas on a printing plate, whereas a gum solution is ejected selectively on the non-image areas to form a gum solution coating in the non-image areas of the printing plate.

More specifically, the head unit 14 is moved over the printing plate P from its one end (starting edge) to the other end (terminal edge) in the main scanning direction (indicated by the arrow X in FIG. 3). During this process, the ink ejecting head 20 and the gum solution ejecting head 22 eject the ink and the gum solution onto the printing plate P in response to the second and first ejection signals to thereby form the image areas coated with the ink and the non-image areas coated with the gum solution on the printing plate P, respectively.

Thereafter, the head unit 14 is moved in the sub scanning direction by a given distance while being moved from the terminal edge to the starting edge in the main scanning direction. The head unit 14 having reached the starting edge of the printing plate P in the main scanning direction is thus moved by a given distance in the sub scanning direction.

Thereafter, while the head unit 14 is moved from the starting edge to the terminal edge in the sub scanning direction, the ink and the gum solution are ejected in response to the second and first ejection signals to thereby form the image areas coated with the ink and the non-image areas coated with the gum solution on the printing plate P, respectively.

The process which includes ejection of the ink and the gum solution while the head unit 14 is moved over the printing plate P in the main scanning direction and its subsequent movement in the sub scanning direction by a given distance is repeated to perform serial scanning as shown in FIG. 3, whereby the image areas coated with the ink and the non-image areas coated with the gum solution are formed on the printing plate P.

In the moving path described above, the image areas coated with the ink and the non-image areas coated with the gum solution are formed during the movement of the head unit 14 in the main scanning direction from the starting edge to the terminal edge. However, the image areas coated with the ink and the non-image areas coated with the gum solution may be formed during the movement of the head unit 14 in the main scanning direction not only from the starting edge to the terminal edge but also from the terminal edge to the starting edge by repeating the following cycle: When reaching the terminal edge of the plate in the main scanning direction, the head unit 14 is moved in the sub scanning direction by a given distance, which is followed by the movement from the terminal edge to the starting edge in the main scanning direction; and when reaching the starting edge in the main scanning direction, the head unit 14 is again moved in the sub scanning direction by a given distance, which is followed by the movement from the starting edge to the terminal edge in the main scanning direction.

The thus formed image areas are heated with the heater 18 that is moved in synchronism with the movement of the head unit 14, whereby the thus fixed image areas, that is, a fixed image is obtained on the printing plate P. Residual heat during the fixation of the image areas through heating by means of the heater 18 serves to dry the gum solution coating.

While the head unit 14 is being moved for scanning, the ink ejecting head 20 forms the image areas coated with the ink, the gum solution ejecting head 22 forms the gum solution coating in the non-image areas, and the heater 18 fixes the image areas through heating, whereby a printing plate having the fixed image, that is, the fixed image areas and the coated non-image areas is obtained.

The plate making apparatus of the present invention is capable of selectively forming the gum solution coating in necessary portions in accordance with the position on the printing plate P by ejecting the gum solution from the gum solution ejecting head (inkjet head) in response to the first ejection signal, which may result in efficient use of the gum solution and a reduction in the amount of the gum solution consumed.

As in the embodiment under consideration, it is preferable to eject the gum solution only in the non-image areas so that the gum solution coating is only formed in the non-image areas, which may result in economical and efficient use of the gum solution and a further reduction in the amount of the gum solution consumed.

The gum solution ejecting head can be provided without any increase in the size of the apparatus by integrating the ink ejecting head with the gum solution ejecting head into one unit as in this embodiment. As a result, the plate making apparatus can be downsized (made compact).

The gum solution coating can be dried using residual heat from the heater without the necessity of providing any particular drying device. In other words, one heater serves to fix the image areas through heating and dry the gum solution coating, which enables more downsizing of the plate making apparatus.

In the embodiment under consideration, residual heat from the heater is used to dry the gum solution coating. However, after the gum solution coating has been formed, the heater may be actuated to heat and dry the gum solution. In other words, the heater may be actuated twice to heat the printing plate after the image areas have been formed thereon and after the gum solution coating has been formed thereon.

In the embodiment under consideration, the ink is ejected from the ink ejecting head to form the image areas, which are then fixed through heating by means of the heater, and thereafter the gum solution is ejected from the gum solution ejecting head to form the gum solution coating. However, this is not the sole case of the present invention, and formation of the image areas with the ink ejecting head and the gum solution coating with the gum solution ejecting head, respectively, may be followed by heat fixation of the image areas and drying of the gum solution coating by means of the heater.

Heat fixation of the image areas and drying of the gum solution coating can be performed at a time by using a single heater (fixing unit). This can be achieved by, for example, changing the layout of the ink ejecting head 20, the heater 18 and the gum solution ejecting head 22 in the head unit 14 from one shown in FIGS. 1 and 2 to one in which the ink ejecting head 20, the gum solution ejecting head 22 and the heater 18 are arranged in this order. In this way, the gum solution coating can be dried without newly providing a particular device for drying the gum solution coating, which enables further downsizing of the apparatus. In addition, fixation and drying are performed at a time, which also enables a decrease in the number of the plate making steps.

A drying unit for drying the gum solution coating may be provided separately from the heater (fixing unit), although the size of the apparatus is increased. Provision of the drying unit enables the gum solution coating to be dried more rapidly and more reliably.

In this embodiment, the head unit is moved in the main scanning direction and the sub scanning direction to form the image areas coated with the ink and the non-image areas coated with the gum solution. However, this is not the sole case of the present invention. For example, it is also possible to use the method in which the head unit is moved only in the main scanning direction, whereas the printing plate is made to travel a given distance in the sub scanning direction each time the printing plate is moved.

A full-line head including the ink ejecting head and the gum solution ejecting head may be used to form the image areas coated with the ink and the non-image areas coated with the gum solution on the entire surface of the printing plate by one scanning operation with the head unit. When the ink ejecting head and the gum solution ejecting head are used as the full-line head, scanning may be performed while the ink ejecting head and the gum solution ejecting head are moved, or while the printing plate is moved.

In order to achieve downsizing of the plate making apparatus, this embodiment is configured in such a manner that the ink ejecting head, the gum solution ejecting head and the heater are integrated into one unit. However, this is not the sole case of the present invention, and the ink ejecting head, the gum solution ejecting head, and the heater may be configured in an independent manner.

An example of the ink ejecting head 20 that can be advantageously used in the plate making apparatus of the present invention is described below in detail with reference to FIGS. 4 and 5.

FIG. 4 is a schematic structural view showing the appearance of the ink ejecting head 20, and FIG. 5 is a schematic structural view showing the periphery of a nozzle 42 of the ink ejecting head 20.

The ink ejecting head 20 has the nozzles 42 for ejecting ink droplets. Each of the nozzles 42 has a recording electrode 44 and a piezoelectric element 46.

The nozzle 42 is made of an insulating material and is a cylinder having in its tip portion an opening with a diameter of 200 μm or less. The nozzle 42 is filled with ink. Part of the ink in the nozzle 42 protrudes from the nozzle through the opening to form a hemispherical or conical meniscus. In this embodiment, the nozzle has a cylindrical shape, but the present invention is not limited thereto and the nozzle may be in the shape of a rectangular solid.

A high surface energy material such as Teflon® is preferably used to form the opening of the nozzle 42. By forming the opening of the nozzle 42 from a high surface energy material, ink can be prevented from spreading out from the nozzle through the opening, leading to the prevention of adverse effects on the recording to be made that may result from an unstable meniscus shape or dirt remaining when the apparatus is turned off.

The nozzle 42 is connected to an ink tank (not shown) which stores ink Q to be fed to the nozzle 42. The ink tank has a pressurizing means (not shown) and feeds the ink Q to the nozzle 42 under pressure from the pressurizing means. The pressurizing means applies an appropriate pressure for keeping the shape of the meniscus 48 constant to feed the ink Q continuously or intermittently under pressure.

The ink tank is preferably provided with a heating means so that the ink can be kept at a predetermined temperature.

The recording electrode 44 is disposed on the outer wall side of the tip portion of the nozzle 42 and is connected to a control unit (not shown). The control unit controls the voltage value and pulse width of a drive voltage to be applied to the recording electrode 44 during ejection or non-ejection of droplets.

When the control unit applies a predetermined voltage corresponding to the second ejection signal to the recording electrode 44, a droplet is ejected from the tip portion of the nozzle 42 through the opening.

The recording electrode 44 may be provided on the inner wall side or outer wall side of the nozzle 42, but is preferably provided on the outer wall side thereof as in this embodiment. Provision of the recording electrode 44 on the outer wall side of the nozzle 42 enables corrosion or other defects due to contact with ink to be excluded.

There is no particular limitation on the distance between the tip of the nozzle 42 and the recording electrode 44. For example, in the case where the position of the recording electrode 44 is moved away from the tip of the nozzle 42 little by little without changing the voltage to be applied, droplets can be appropriately ejected in this embodiment even when the recording electrode is at a distance of 10 cm or more from the tip of the nozzle 42.

The ink ejecting head 20 in this embodiment preferably has the piezoelectric element 46.

The piezoelectric element 46 is disposed on the outer wall side of the nozzle 42 upstream of the recording electrode in the ink flow direction. The piezoelectric element 46 is made of a material which is deformable in response to an applied voltage, and applies pressure to the ink filled into the nozzle in synchronism with the application of the voltage to the recording electrode 44. Recording can be made in a more consistent manner by applying pressure to the ink with the piezoelectric element 46 as described above.

In this embodiment, the nozzle 42 is formed from an insulating material and a predetermined voltage is applied to the recording electrode 44 in response to the second ejection signal, thereby ejecting droplets. However, this is not the sole case of the present invention. For example, when corrosion or clogging due to contact with the ink used is negligible, droplets may be ejected by directly applying a signal voltage to the nozzle which is made of a metal and is not particularly provided with any recording electrode.

The ink ejecting operation with the ink ejecting head 20 is described below.

Ink is fed under pressure from the ink tank to the nozzle 42 and an ink meniscus is formed in the opening in the tip portion of the nozzle 42.

When the control unit applies a predetermined voltage to the recording electrode 44 in response to the second ejection signal in the state in which the meniscus is formed, the meniscus vibrates (expands and contracts) in the tip of the nozzle 42 and ultimately expands toward the printing base plate P, where the ink adheres to form a dot. Alternatively, the tip of the meniscus is divided to produce a small droplet, which is then separated from the meniscus to be sprayed toward and adhered to the printing base plate P, where a dot is formed.

The voltage to be applied to the recording electrode 44 is thus controlled in accordance with the second ejection signal to form ink dots on the printing base plate P thereby forming the image areas.

The inkjet head having been described above with reference to FIGS. 4 and 5 can also be advantageously used as the gum solution ejecting head 22.

Next, an example of the gum solution advantageously used in the plate making apparatus of the present invention is described more specifically.

A desensitizer used in the desensitizing treatment of a lithographic printing plate that uses an aluminum plate as the support can be effectively employed for the gum solution. A preferred example of the desensitizer includes an aqueous solution containing at least one selected from the group consisting of a hydrophilic organic polymer compound, hexametaphosphoric acid and a salt thereof, and phytic acid and a salt thereof.

Specific examples of the hydrophilic organic polymer compound include gum arabic; dextrin; an alginate such as sodium alginate; water-soluble celluloses such as carboxymethylcellulose, hydroxyethylcellulose and hydroxypropylmethylcellulose; a water-soluble copolymer containing polyvinyl alcohol, polyvinylpyrrolidone, polyacrylamide or acrylamide unit; a copolymer containing polyacrylic acid or acrylic acid unit; a copolymer containing polymethacrylic acid or methacrylic acid unit; a copolymer of vinyl methyl ether and maleic anhydride, a copolymer of vinyl acetate and maleic anhydride; and phosphoric acid-modified starch. Of these, gum arabic is preferred because of its stronger desensitizing action. These hydrophilic polymer compounds can be used as appropriate in combination of two or more, at a concentration of preferably about 1 to 40 wt % and more preferably 3 to 30 wt %.

Specific examples of the hexametaphosphate include alkali metal salts or ammonium salts of hexametaphosphoric acid. Examples of the alkali metal salts or ammonium salts of hexametaphosphoric acid include sodium hexametaphosphate, potassium hexametaphosphate and ammonium hexametaphosphate. Specific examples of the phytic acid salt include alkali metal salts such as sodium salt, potassium salt and lithium salt, ammonium salts, and amine salts. Exemplary amine salts include diethylamine, triethylamine, n-propylamine, di-n-propylamine, tri-n-propylamine, n-butylamine, n-amylamine, n-hexylamine, laurylamine, ethylenediamine, trimethylenediamine, tetramethylenediamine, pentamethylenediamine, hexamethylenediamine, ethanolamine, diethanolamine, triethanolamine, allylamine and aniline. The phytate may be a normal salt in which 12 hydrogen atoms of the acid are all substituted, or a hydrogen salt (acid salt) in which part of the hydrogen atoms in the acid are substituted. The phytates that may be used include a simple salt composed of a salt of one base, and a double salt containing two or more bases as its ingredients. These compounds can be used alone or in combination of two or more.

It is preferred for the desensitizer used in the present invention to further contain a metal salt of a strong acid to enhance the desensitizing action. Specific examples of the metal salt of the strong acid include sodium salts, potassium salts, magnesium salts, calcium salts and zinc salts of nitric acid, sulfuric acid and chromic acid; and sodium fluoride and potassium fluoride. These metal salts of the strong acids may be used in combination of two or more in an amount of about 0.01 to 5 wt % based on the total amount of the desensitizer. The pH value of the desensitizer used in the present invention is preferably adjusted to lie within the acidic range, more preferably 1 to 5, and most preferably 1.5 to 4.5. Therefore, when the aqueous phase does not have an acidic pH, an acid is further added to the aqueous phase. Examples of the acid that may be added as the pH adjuster include mineral acids such as phosphoric acid, sulfuric acid and nitric acid; and organic acids such as citric acid, tannic acid, malic acid, glacial acetic acid, lactic acid, oxalic acid, p-toluenesulfonic acid, and organic phosphonic acid. Among these, phosphoric acid is particularly excellent because it functions as the pH adjuster and enhances the desensitizing action. The desensitizer preferably contains 0.01 to 20 wt % and most preferably 0.1 to 10 wt % of phosphoric acid in relation to the total amount of the desensitizer.

The desensitizer that may be used in the present invention preferably contains a wetting agent and/or a surfactant, whereby the coating properties of the desensitizer can be enhanced. Specific examples of the wetting agent that may be preferably used include lower polyhydric alcohols such as ethylene glycol, diethylene glycol, triethylene glycol, propylene glycol, butylene glycol, pentanediol, hexylene glycol, tetraethylene glycol, polyethylene glycol, dipropylene glycol, tripropylene glycol, glycerol, sorbitol, and pentaerythritol. Glycerol is particularly preferred. Exemplary surfactants that may be used include nonionic surfactants such as polyoxyethylene alkylphenyl ether and polyoxyethylene polyoxypropylene block copolymer; anionic surfactants such as fatty acid salts, alkyl sulfates, alkylbenzenesulfonates, alkylnaphthalenesulfonates, dialkylsulfosuccinates, alkyl phosphates, and a condensation product of naphthalene sulfonic acid and formaldehyde; and amphoteric surfactants of betaine, glycine, alanine and sulfobetaine types. The desensitizer may contain such wetting agent and/or surfactant in an amount of preferably about 0.5 to 10 wt % and more preferably 1 to 5 wt % in relation to the total amount of the desensitizer. The desensitizer used in the present invention may also contain fillers such as silicon dioxide, talc and clay in an amount of 2 wt % or less, and a dye or a pigment in an amount of 1 wt % or less.

The desensitizer used in the present invention is a hydrophilic aqueous solution as described above, but emulsion type desensitizers as described in U.S. Pat. No. 4,253,999, U.S. Pat. No. 4,268,613 and U.S. Pat. No. 4,348,954 may also be used. The amount of the desensitizer applied and dried is in a range of 0.001 to 50 g/m² and preferably 0.01 to 10 g/m².

Next, the printing base plate that may be advantageously used in the plate making apparatus of the present invention is described.

Dimensionally stable sheets are appropriate for the support that may be used in the printing base plate as described in the foregoing pages. Examples thereof include paper; paper onto which a plastic (e.g., polyethylene, polypropylene or polystyrene) is laminated; a metal sheet made of, for example, aluminum, zinc or copper; a plastic film made of, for example, cellulose diacetate, cellulose triacetate, cellulose propionate, cellulose butyrate, cellulose acetate butyrate, cellulose nitrate, polyethylene terephthalate, polyethylene, polystyrene, polypropylene, polycarbonate, polyvinyl acetal; and paper or a plastic film onto which such metal is laminated or vapor-deposited. A polyester film and an aluminum sheet are supports that may be preferably used.

A lightweight aluminum sheet which is excellent in surface treating capability, workability and corrosion resistance is preferably used for the support of the printing base plate. The aluminum material to be used for this purpose is selected from the group consisting of aluminum; aluminum-containing alloys such as JIS 1050 materials, JIS 1100 materials and JIS 1070 materials, Al—Mg alloys, Al—Mn alloys, Al—Mn—Mg alloys, Al—Zr alloys and Al—Mg—Si alloys; and a plastic film or paper onto which aluminum or such aluminum alloy is laminated or vapor-deposited. A composite sheet obtained by coating a polyethylene terephthalate film with an aluminum sheet as described in JP 48-18327 B may also be used.

The surface of an aluminum sheet can be subjected to graining treatment obtain a printing base plate and to other surface treatments to obtain a printing plate having image areas formed on the surface thereof. The graining treatment includes mechanical graining, chemical graining and electrochemical graining, which are carried out singly or in combination. It is also preferable to carry out anodizing treatment for ensuring the resistance to surface scuffing and a treatment for enhancing the hydrophilicity.

The surface treatments carried out on the support is described below. Prior to graining the aluminum sheet, the aluminum sheet may be degreased as required with, for example, a surfactant, an organic solvent or an alkaline aqueous solution for removing rolling oil from the surface thereof. When an alkali is used, the aluminum sheet may be then neutralized with an acidic solution and subjected to desmutting treatment.

Next, the surface of the support is grained in order to enhance the adhesion between the support and the image areas and impart the water retentivity to non-image areas. Specific means for graining treatment include mechanical graining (e.g., sandblasting) and chemical graining for graining the surface with an etchant including an alkali or acid, or a mixture thereof. Any other known methods including electrochemical graining method, a method in which the surface is grained by adhering particles to the support material with an adhesive or using a process having an adhesion effect, and a method in which a strip or roll having fine irregularities is pressed against a support material to transfer the irregularities thereto can be applied.

Some of the graining methods may be carried out in combination and the sequence and the number of repetitions thereof can be arbitrarily selected. Smut develops on the surface of the support obtained by carrying out the graining treatment as described above, so it is generally preferable to carry out rinsing with water or alkali etching treatment as appropriate in order to remove the smut.

When being made of aluminum, the support is pretreated as described above, which is usually followed by anodization to enhance the corrosion resistance, chemical resistance and water retentivity, whereby an oxide film is formed on the support. Any material can be employed for the electrolyte used in anodizing treatment of the aluminum sheet, as long as a porous oxide film can be formed thereon. In general, sulfuric acid, phosphoric acid, oxalic acid, hydrochloric acid, nitric acid, boric acid, chromic acid, sulfamic acid and benzenesulfonic acid, and a mixed acid thereof are used. The concentration of such electrolyte is determined as appropriate depending on the type of the electrolyte. The anodizing treatment conditions vary according to the electrolyte used, although it is generally suitable for the solution to have an electrolyte concentration of 1 to 80 wt % and a temperature of 5 to 70° C., and for the current density to be 5 to 60 A/dm², the voltage to be 1 to 100 V, and the electrolysis time to be 10 seconds to 5 minutes. The anodized layer weight is preferably at least 1.0 g/m² and more preferably 2.0 to 6.0 g/m². When the anodized layer weight is less than 1.0 g/m², the press life is not long enough and scratches are readily formed in the non-image areas of the printing plate, which may readily cause during printing, so-called “scumming” which is a phenomenon of adhesion of ink to the scratched portions.

The anodized aluminum surface may be then subjected to sealing treatment. Such sealing treatment is carried out by immersing the support in hot water or a hot aqueous solution containing an inorganic or organic salt or placing it in a steam bath. The aluminum support may be subjected to hydrophilizing treatment such as alkali metal silicate treatment or immersion of the support in an aqueous solution containing potassium hexafluorozirconate, a phosphate or the like.

An intermediate layer may be formed to enhance the adhesion between the support and the image areas formed with the ink ejecting head. Diazo resins, phosphonic or phosphoric acid compounds, aluminum compounds such as aluminum alkoxides, and organic silicone compounds for use in the adhesion layer provided on the aluminum support as described in JP 2001-109139 A may be used for the intermediate layer for the purpose of enhancing the adhesion. The thickness of the intermediate layer is arbitrarily determined, but the intermediate layer must have a sufficient thickness for the support to have a uniform bind formation reaction with the overlying image areas during exposure to light. The dried solid amount of the intermediate layer is usually in a range of about 1 to 100 mg/m² and desirably 5 to 40 mg/m². After the above-mentioned treatments have been carried out on the front surface of the support or an undercoat has been formed thereon, a back coating is formed as required on the rear surface of the support. Examples of such back coating that may be preferably used include a coating layer made of an organic polymer compound as described in JP 5-45885 A and a metal oxide coating layer as described in JP 6-35174 A, which is obtained by hydrolysis and polycondensation of an organic or inorganic metal compound.

As for the preferable properties of the support of the printing base plate, that is, the support for the printing plate, the center line average roughness is preferably in a range of 0.10 to 1.2 μm. At a center line average roughness of at least 0.10 μm, the adhesion to the image areas exceeding a certain level is achieved, thus enabling long press life to be maintained. At a center line average roughness of 1.2 μm or less, the scumming resistance during printing can be enhanced. When the image areas are formed through exposure and development, the support has preferably a color density, given as the reflection density, of 0.15 to 0.65. A color density of at least 0.15 prevents image formation from being hindered due to halation during image exposure, and a color density of not more than 0.65 enables good image visibility in the plate-checking operation following the development, thus enhancing plate-checking capability.

Next, ink that may be advantageously used in the plate making apparatus of the present invention is described.

Well-known many solid inks can be used for the ink. For example, use may be made of inks disclosed in JP 55-54368 A, JP 58-108271 A, JP 61-159470 A, JP 61-141750 A, JP 61-83268 A, JP 62-41112 B, JP 62-48774 A, JP 62-295973 A, JP 64-27953 A, JP 64-295973 A, JP 63-501430 A, JP 2-206661 A, JP 2-229870 A, JP 5-194897 A, JP 5-311101 A, JP 6-107987 A, JP 6-240195 A, JP 6-116521 A, JP 2-281083 A, JP 3-153773 A, JP 4-117468 A, JP 7-70490 A, JP 8-165447 A, JP 9-3377 A, JP 9-71743 A, JP 5-506881 A, JP 4-74193 B, and JP 7-115470 B.

There is no particular limitation on the material of the vehicle for the solid ink in the present invention, but the vehicle can be composed of one or more components selected from the group consisting of rosin, rosin derivatives, monoamides, bisamides, tetraamides, polyamides, polyesters, polyvinyl acetate, acrylic and methacrylic polymers, styrene polymers, ethylene/vinyl acetate copolymers, polyketones, silicones, coumarone, fatty acids, fatty acid amides, glycerides, natural resins, natural and synthetic waxes, fatty acid ester amides, fatty acid esters, plasticizers, higher alcohols, and ketones.

More specifically, use can be made of Pinecrystal KR-610, KR-612, KR-604, KE-311, KE-100, KE-359, KE-828 (available from Arakawa Chemical Industries, Ltd.) for the rosin or the rosin derivatives.

Exemplary tetraamides that may be used include UNIREZ 2224 and UNIREZ 2970 (available from Union Camp Corporation). Exemplary polyamides that may be used include SYLVAMID E-5 (available from Arizona Chemical Company), DPX 335-10, DPX H-415, DPX 335-11, DPX 830, DPX 850, DPX 925, DPX 927, DPX 1160, DPX 1163, DPX 1175, DPX 1196, DPX 1358, Versamid 711, Versamid 725, Versamid 930, Versamid 940, Versalon 1117, Versalon 1138, Versalon 1300 (available from Henkel-KGaA), Tohmide 391, Tohmide 393, Tohmide 394, Tohmide 395, Tohmide 397, Tohmide 509, Tohmide 535, Tohmide 558, Tohmide 560, Tohmide 1310, Tohmide 1396, Tohmide 90 and Tohmide 92 (available from Fuji Kasei Kogyo Co., Ltd.).

Use can be made of KTR 2150 (available from Kao Corporation) for the polyester; AC401, AC540 and AC580 (available from Allied Chemical corporation) for the polyvinyl acetate; Silicone SH6018 (available from Dow Corning Toray Silicone Co., Ltd.), Silicone KR 215, Silicone KR 216 and Silicone KR 220 (available from Shin-Etsu Chemical Co., Ltd.) for the silicone; and Escuron G-90 (available from Nippon Steel Chemical Co., Ltd.) for the coumarone.

A component selected from the group consisting of acids such as palmitic acid, oleic acid, stearic acid, arachic acid, behenic acid, lignoceric acid, cerotic acid, montanic acid and melissic acid and esters thereof can be used for the fatty acid, but use can also be made of two or more of them in combination.

A component selected from the group consisting of lauric acid amide, stearic acid amide, oleic acid amide, erucic acid amide, ricinoleic acid amide, stearic acid ester amide, palmitic acid amide, behenic acid amide and brassidic acid amide, or a mixture of two or more thereof may be used for the fatty acid amide. A component selected from the group consisting of N,N′-2-hydroxystearic acid amide, N,N′-ethylenebisoleic acid amide, N,N′-xylenebisstearic acid amide, monomethylol stearate amide, N-oleylstearic acid amide, N-stearylstearic acid amide, N-oleylpalmitic acid amide, N-stearylerucic acid amide, N,N′-dioleyladipic acid amide, N,N′-dioleylsebacic acid amide, N,N′-distearylisophthalic acid amide, and 2-stearamide ethyl stearate, or a mixture of two or more thereof can be used for the N-substituted fatty acid amide.

A component selected from the group consisting of rosin ester, lanolin ester, hardened castor oil, partially hydrogenated castor oil, extremely hardened soybean oil, extremely hardened rapeseed oil and extremely hardened vegetable oil, or a mixture of two or more thereof can be used for the glyceride.

Exemplary waxes that may be selected include petroleum waxes such as paraffin wax and microcrystalline wax; vegetable waxes such as candelilla wax and carnauba wax; special ester wax and polyethylene wax. More specifically, use can be made of deodorized and purified carnauba wax No. 1 and purified candelilla wax No. 1 (available from Cerarica Noda Co., Ltd.), Syncrowax ERL-C and Syncrowax HR-C (available from Croda) and KF2 (available from Kawaken Fine Chemicals Co., Ltd.). Exceparl DS-C2 (Kao Corporation) and Kawaslip-L, Kawaslip-R (available from Kawaken Fine Chemicals Co., Ltd.) are also selected for the special ester wax. Esters of higher fatty acids with higher alcohols such as myricyl cerotate, ceryl cerotate, ceryl montanate, myricyl palmitate, myricyl stearate, cetyl palmitate and cetyl stearate are also selected.

The fatty acid ester amides that may be selected are CPH-380N (available from C. P. Hall Company) and Kawaslip SA (available from Kawaken Fine Chemicals Co., Ltd.).

The fatty acid esters that may be desirably used are those of monohydric or polyhydric alcohols. For example, sorbitan monopalmitate, sorbitan monostearate, sorbitan monobehenate, polyethylene glycol monostearate, polyethylene glycol distearate, propylene glycol monostearate and ethylene glycol distearate are selected. More specifically, use can be made of Rheodol SP-S10, Rheodol SP-S30, Rheodol SA10, Emasol P-10, Emasol S-10, Emasol S-20, Emasol B, Rheodol Super SP-S10, Emanon 3199, Emanon 3299 and Exceparl PE-MS (available from Kao Corporation) and Unister M9676 and Unister M2222SL (available from NOF CORPORATION).

Examples of the glycerol fatty acid ester that may be selected include stearic acid monoglyceride, palmitic acid monoglyceride, oleic acid monoglyceride, and behenic acid monoglyceride. More specifically, Rheodol MS-50, Rheodol MS-60, Rheodol MS-165, Rheodol MO-60 and Exceparl G-MB (available from Kao Corporation) may be selected.

Desirable plasticizers are Phosphoric acid esters, phthalic acid esters, aliphatic monochlorate esters, aliphatic dichlorate esters, dihydric alcohol esters, oxyacid esters, chlorinated paraffins, and epoxy compounds. Exemplary plasticizers that may be selected include tributyl phosphate, tri(2-ethylhexyl)phosphate, triphenyl phosphate, tricresyl phosphate, dimethyl phthalate, diethyl phthalate, dibutyl phthalate, diheptyl phthalate, di-n-octyl phthalate, di(2-ethylhexyl)phthalate, diisononyl phthalate, octyldecyl phthalate, diisodecyl phthalate, butylbenzyl phthalate, butyl oleate, glycerol monooleic acid ester, dibutyl adipate, di-n-hexyl adipate, di(2-ethylhexyl)adipate, alkyl adipate 610, di(2-ethylhexyl)azelate, dibutyl sebacate, di(2-ethylhexyl)sebacate, diethylene glycol dibenzoate, triethylene glycol di(2-ethyl butyrate), methyl acetyl ricinolate, butyl acetyl ricinolate, butyl phthalyl butyl glycolate, tributyl acetyl citrate, chlorinated paraffin, chlorinated biphenyl, 2-nitrobiphenyl, dinonylnaphthalene, o- and p-toluenesulfonethylamide, and methyl abietate. More specifically, use can be made of ADK CIZER (ADEKA CORPORATION), Vinycizer 20, 75, 85, 90 and 105 (Kao Corporation), Kyowanol M, D (Kyowa Hakko Kogyo Co., Ltd.), Newcizer (NOF CORPORATION), Sansocizer DUP and DNP (New Japan Chemical Co., Ltd.), Monocizer DBP, DNP, W-540-L (Dainippon Ink and Chemicals, Incorporated), Diacizer 110, 148, 160, 180, 269, 388, 600 series, 1170 (Mitsubishi Chemical Corporation), and PM-7200T (Kawaken Fine Chemicals Co., Ltd.).

Dyes and pigments which are fully dispersed in the vehicle, are excellent in thermal stability and do not adversely affect the printing ink during printing are desirably used for the colorant. Any colorant such as a fat dye can be used as long as the colorant used is compatible with other ink ingredients.

The colorant is added in order to visualize the state of ink adhesion thereby facilitating the evaluation. The colorant is added in an appropriate amount of 0.2 to 5 wt % in relation to the amount of ink. An amount of less than 0.2 wt % lowers the image quality, whereas an amount of more than 5 wt % adversely affects the viscosity characteristics of the ink.

Two or more colorants can be timely used in combination for color adjustment. Various additives such as a surface treating agent, a surfactant, a viscosity reducer, an antioxidant, an antiseptic and a ultraviolet absorber can be further mixed into the ink to further impart the functionality to the ink.

The solid ink that may be preferably used has been mentioned above, but the present invention is not limited thereto. Various inks including an ink having resin particles dispersed in a solvent, an ink having fine metal particles dispersed in a solvent, an ink having a resin component dissolved in a solvent, and an ultraviolet curable ink can be used. When the ultraviolet curable ink is used, lamps (e.g., xenon lamp, mercury lamp and UV-LED (Ultraviolet Light Emitting Diode)) containing a large amount of the ultraviolet component are used instead of the heater.

The plate making apparatus of the present invention has been described above in detail. However, the present invention is not limited to the above-mentioned embodiment, and various improvements and modifications may of course be made without departing from the scope of the present invention.

To be more specific, the image areas are formed with the ink ejecting head in the embodiment described above. However, this is not the sole case of the present invention and the image areas may be formed through exposure and development of the photosensitive layer formed on the support, for example, the photosensitive layer of the conventional lithographic printing plate.

Even when the gum solution coating is formed by ejecting the gum solution from the inkjet head onto the non-image areas of the printing plate on which the image areas have been formed, the gum solution can be employed with a high degree of efficiency as in the embodiment described above.

What is claimed is:

1. A plate making apparatus for making a lithographic printing plate, comprising:
a first inkjet head which ejects selectively a plate surface-protecting solution in response to a first ejection signal onto a printing plate on which an image has been recorded.

2. The plate making apparatus according to claim 1, wherein said first inkjet head ejects selectively said plate surface-protecting solution on non-image areas of said printing plate.

3. The plate making apparatus according to claim 1, further comprising a drying unit which dries said plate surface-protecting solution ejected selectively onto said printing plate with said first inkjet head.

4. The plate making apparatus according to any one of claims 1, further comprising a second inkjet head which ejects an image forming material onto a printing base plate on which image areas are not formed in response to a second ejection signal to form image areas on said printing base plate, thereby making said printing plate on which said image including said image areas and non-image areas has been recorded.

5. The plate making apparatus according to claim 4, further comprising a fixing unit which heats said image forming material ejected onto said printing plate with said second inkjet head so that said image forming material is fixed as said image areas.

6. The plate making apparatus according to claim 5, wherein said fixing unit heats said image forming material ejected onto said printing plate to fix it as said image areas, and also dries said plate surface-protecting solution ejected selectively with said first inkjet head.

7. The plate making apparatus according to claim 6, wherein said fixing unit heats the image recording material ejected onto said printing plate to fix it as said image areas, while simultaneously drying said plate surface-protecting solution.

8. The plate making apparatus according to claim 1, wherein said image comprises ink receptive image areas and ink repellent non-image areas which have been formed on said printing plate, and said printing plate is ready to be used as a lithographic printing plate.

9. The plate making apparatus according to claim 1, wherein said first ejection signal is based on image data for recording said image.

10. The plate making apparatus according to claim 4, wherein said second ejection signal is based on image data for recording said image.
